(19) United States
(12) Patent Application Publication
(10) Pub. No.: US 2026/0364704 A1
(43) Pub. Date: Nov. 19, 2026

(54) TELE-MANUFACTURING SYSTEM AND METHOD

(71) Applicant: Edison Welding Institute, Inc, Columbus, OH (US)

(72) Inventors: Constance T. Reichert LaMorte, Columbus, OH (US); Paul A. Blomquist, Columbus, OH (US)

(21) Appl. No.: 19/750,852

(22) Filed: Jul. 22, 2026

Related U.S. Application Data
(63) Continuation of application No. 17/496,948, filed on Oct. 8, 2021.

(51) Int. Cl. B23K 9/10; G05B 19/418; G06F 3/01; G06F 3/0346; G06Q 50/04

(52) U.S. Cl. CPC B23K 9/1087; G05B 19/418; G06F 3/016; G06Q 50/04; G05B 2219/31457; G05B 2219/40174; G05B 2219/40183; G05B 2219/40195; G06F 3/0346

(57) ABSTRACT

A tele-manufacturing system comprising a manufacturing environment containing equipment used for a manufacturing process; a plurality of sensors positioned within the manufacturing environment in proximity to the manufacturing equipment, wherein each sensor is configured to gather data from the manufacturing environment; at least one digitizer in communication with the sensors for receiving data from sensors and converting the data into one or more three-dimensional digital maps or point clouds; at least one processor in communication with the at least one digitizer, wherein the processor includes software for receiving and analyzing the digital maps or point clouds; and at least one manual controller in communication with the processor, wherein the manual controller receives motion input from a user, wherein the software on the processor mathematically transforms the motion input into corresponding motion commands that are sent to the manufacturing equipment by the processor, and wherein the manufacturing equipment, which is physically remote from the at least one controller, executes the motion commands in real-time during the manufacturing process.

### CROSS-REFERENCE TO RELATED APPLICATIONS

This patent application is a continuation of U.S. patent application Ser. No. 17/496,948 filed on Oct. 8, 2021 and entitled “Tele-Manufacturing System”, the disclosure of which is hereby incorporated by reference herein in its entirety and made part of the present U.S. utility patent application for all purposes.

### BACKGROUND

The inventive subject matter disclosed herein relates in general to industrial manufacturing and fabricating systems and methods and more specifically to a manufacturing or welding system operated from a remote location, also referred to as a “tele-manufacturing” or “tele-welding” system. Welding, as an industry, is currently challenged by a variety of factors including a decreasing number of skilled welders; a lack of individuals wanting to enter what are traditionally considered to be “manual” trades; and an ever-increasing list of hazards and limitations related to welding and other hot work activities that make finding and keeping experienced welders difficult. Additionally, efforts within the industry to optimize weight and space in fabrication processes have resulted in the construction of manufacturing facilities that are basically inaccessible to humans. Accordingly, there is an ongoing need for welding systems, processes, and methods that permit qualified welders to enter and remain in the workforce regardless of physical limitations, age, or other perceived obstacles such as those described above.

### SUMMARY

The following provides a summary of certain example implementations of the disclosed inventive subject matter. This summary is not an extensive overview and is not intended to identify key or critical aspects or elements of the disclosed inventive subject matter or to delineate its scope. However, it is to be understood that the use of indefinite articles in the language used to describe and claim the disclosed inventive subject matter is not intended in any way to limit the described inventive subject matter. Rather the use of “a” or “an” should be interpreted to mean “at least one” or “one or more”.

One implementation of the disclosed technology provides a first system for manually controlling a manufacturing process remotely, comprising a manufacturing environment, wherein the manufacturing environment contains equipment used for or related to a manufacturing process; at least one sensor positioned within the manufacturing environment in proximity to the manufacturing equipment, wherein the at least one sensor is configured to gather data from the manufacturing environment; at least one digitizer in communication with the plurality of sensors for receiving data from sensors and converting the data into one or more three-dimensional digital maps; at least one processor in communication with the at least one digitizer, wherein the at least one processor includes software for receiving and analyzing the at least one three-dimensional digital map; and at least one manual controller in communication with the processor, wherein the at least one manual controller receives motion input from a user of the manual controller, wherein the software on the processor mathematically transforms the motion input into corresponding motion commands that are sent to the manufacturing equipment by the processor, and wherein the manufacturing equipment, which is physically remote from the at least one controller, executes the motion commands in real-time during the manufacturing process.

The system may further comprise a computer network across which the processor communicates with the manufacturing equipment. The manufacturing equipment may include welding equipment, measurement equipment, inspection equipment, remote assembly equipment, or combinations thereof. The manufacturing equipment may move with at least three or at least six degrees of freedom. The at least one sensor may be an optical sensor or an auditory sensor. The digitizer may converts the data received from the sensors into a point cloud. The processor may be a computer. The at least one manual controller may be a hand-held stylus, a computer mouse, or a joystick. The at least one manual controller may move with at least three or at least six degrees of freedom. The at least one manual controller may be configured to provide haptic feedback to the user of the controller.

Another implementation of the disclosed technology provides a second system for manually controlling a manufacturing process remotely, comprising a manufacturing environment, wherein the manufacturing environment contains equipment used for or related to a manufacturing process, and wherein the manufacturing equipment moves with at least three or at least six degrees of freedom; at least one sensor positioned within the manufacturing environment in proximity to the manufacturing equipment, wherein the at least one sensor is configured to gather data from the manufacturing environment; at least one digitizer in communication with the plurality of sensors for receiving data from sensors and converting the data into one or more three-dimensional digital maps; at least one processor in communication with the at least one digitizer, wherein the at least one processor includes software for receiving and analyzing the at least one three-dimensional digital map; and at least one manual controller in communication with the processor, wherein the manual controller moves with at least three or at least six degrees of freedom, wherein the at least one manual controller receives motion input from a user of the manual controller, wherein the software on the processor mathematically transforms the motion input into corresponding motion commands that are sent to the manufacturing equipment by the processor, and wherein the manufacturing equipment, which is physically remote from the at least one controller, executes the motion commands in real-time during the manufacturing process.

The system may further comprise a computer network across which the processor communicates with the manufacturing equipment. The manufacturing equipment may include welding equipment, measurement equipment, inspection equipment, remote assembly equipment, or combinations thereof. The at least one sensor may be an optical sensor or an auditory sensor. The digitizer may converts the data received from the sensors into a point cloud. The processor may be a computer. The at least one manual controller may be a hand-held stylus, a computer mouse, or a joystick. The at least one manual controller may be configured to provide haptic feedback to the user of the controller.

Still another implementation of the disclosed technology provides a method for manually controlling a manufacturing process remotely, comprising installing equipment used for or related to a manufacturing process in a manufacturing environment; positioning at least one sensor positioned within the manufacturing environment in proximity to the manufacturing equipment, wherein the at least one sensor is configured to gather data from the manufacturing environment; connecting at least one digitizer to the plurality of sensors for receiving data from sensors and converting the data into one or more three-dimensional digital maps; connecting at least one processor to the at least one digitizer, wherein the at least one processor includes software for receiving and analyzing the at least one three-dimensional digital map; and connecting at least one manual controller to the processor, wherein the at least one manual controller receives motion input from a user of the manual controller, wherein the software on the processor mathematically transforms the motion input into corresponding motion commands that are sent to the manufacturing equipment by the processor, and wherein the manufacturing equipment, which is physically remote from the at least one controller, executes the motion commands in real-time during the manufacturing process.

The method may further comprise providing a computer network across which the processor communicates with the manufacturing equipment. The manufacturing equipment may include welding equipment, measurement equipment, inspection equipment, remote assembly equipment, or combinations thereof. The manufacturing equipment may move with at least three or at least six degrees of freedom. The at least one sensor may be an optical sensor or an auditory sensor. The digitizer may convert the data received from the sensors into a point cloud. The processor may be a computer. The at least one manual controller may be a hand-held stylus, a computer mouse, or a joystick. The at least one manual controller may move with at least three or at least six degrees of freedom. The at least one manual controller may be configured to provide haptic feedback to the user of the controller.

It should be appreciated that all combinations of the foregoing concepts and additional concepts discussed in greater detail below (provided such concepts are not mutually inconsistent) are contemplated as being part of the inventive subject matter disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed inventive subject matter and, together with the general description given above and detailed description given below, serve to explain the principles of the disclosed subject matter, and wherein:

FIG. 1 is a block diagram of an example implementation of the disclosed tele-welding system showing the basic components of the system; and

FIG. 2 is a flow chart of an example method for using an example implementation of the disclosed tele-welding system.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed inventive subject matter. Accordingly, the following implementations are set forth without any loss of generality to, and without imposing limitations upon, the claimed subject matter.

The disclosed technology includes tele-manufacturing systems and methods that enable equipment operation from one or more locations that are physically remote from where the manufacturing is actually occurring. The term “tele-operation” generally refers to the operation of a system or a machine from a distance and is somewhat similar in meaning to the term “remote control”; however, the term is typically used in research, academic, and technical contexts. Tele-operation is most commonly associated with robotics and mobile robots, but may be applied to an entire range of circumstances in which a device or machine is operated by a person from a distance. Certain implementations of the disclosed technology provides a system that permits workers to operate welding equipment from a remote location while still being in complete control of the equipment. This system allows welding professionals to gain exposure and confidence with regard to various manufacturing techniques and processes and may be used to direct future efforts in the application of remote-controlled manufacturing technologies by allowing any person, at any location, to be an active participant in manufacturing. Various alternate implementations of the disclosed technology include measurement equipment, inspection equipment, remote assembly equipment, or combinations thereof. Remote assembly equipment may include end effectors or other mechanical devices that may be manipulated by a remote user.

The disclosed tele-welding system permits an individual to direct a welding process from a remote location by controlling welding arc on, welding arc off, welding travel speed, and welding torch angles and motions, thereby permitting the individual to make various decisions regarding the welding of a part that is not in their immediate visual or auditory range. Tele-welding differs from remote welding in that the welding machinery at the remote location (e.g., robot, manipulator, mechanization, automation) is not running an independent program or motion plan. The person who is remote from the machinery is in control of the welding machinery and makes decisions to move the machinery by use of a hand-held stylus device or similar device.

The disclosed system differs from virtual reality (VR) in that the hand-held stylus is an actual physical device that has various degrees of rotational freedom and provides encoded position information from each axis when queried, and converts the motion of the stylus device into motion on a live articulated machine (robot) with various degrees of rotational freedom. The disclosed system differs from off-line planning control systems in that motion control is done in real-time with only sub-second delays or latency between user movement of the hand-held stylus and motion produced on remote machinery. The difference between the disclosed control system and a traditional master-follower control system is that the degrees of freedom of motion on the stylus do not produce the same degrees of freedom motion result on the robot, i.e., the motion output of the robot and hand-held stylus are not identical. Additionally, the number of degrees of freedom present on the hand-held stylus device (or other type of controller) does not necessarily match the number of degrees of freedom on the robot. In some example implementations of the disclosed technology, the controller includes three degrees of freedom and the robot includes three degrees of freedom. In other example implementations, the controller includes six degrees of freedom and the robot includes six degrees of freedom. In other example implementations, the controller includes more than three degrees of freedom and the robot includes fewer than six degrees of freedom. Numerous combinations of degrees of freedom are possible. The last three degrees of freedom present on the controller do not necessarily affect the first three degrees of freedom present on the controller; accordingly, the robot may only include three degrees of freedom and still be effective for manufacturing purposes in accordance with the disclosed system.

Regarding the local manipulator (e.g., stylus) to remote machinery (e.g., robot) motion in implementations wherein the stylus (controller) and articulated machine (robot) both include six degrees of freedom, the robot six degrees of freedom includes X, Y, Z, roll, pitch and yaw (Rx, Ry, Rz) direction motions generated with the six coordinated axes of the articulated robot. The six degrees of freedom of the stylus device include X, Y and Z direction motion and three additional gimbaled axes that provide the additional three degrees of freedom. The physical size of the stylus and the remote machinery differ from one another and the configuration of the connections of axes on the stylus is different than the configuration of the axes on the remote machinery. The disclosed system uses mathematical transformations to convert the six degrees of freedom on the hand-held stylus to motions on the remote articulated machinery which represent typical motions a manual welder would make when moving a welding torch during welding (e.g., weaving). The tele-welding software program completes the transformations between the two articulated motion systems and commands the remote machinery to produce the desired transformed motion.

Implementations of the disclosed system wherein both the stylus (controller) and remote robot include six degrees of freedom produce welder motions which replicate or closely approximate the physical movements or motions of an actual human welder. These “welder motions” include: weld travel direction, weld travel speed, weld weave width, weld weave speed, weave orientation with respect to the face of the weld (or position of wire normal to joint), torch travel angle, torch workpiece angle, and torch tip roll (about the wire or TCP (tool center point)).

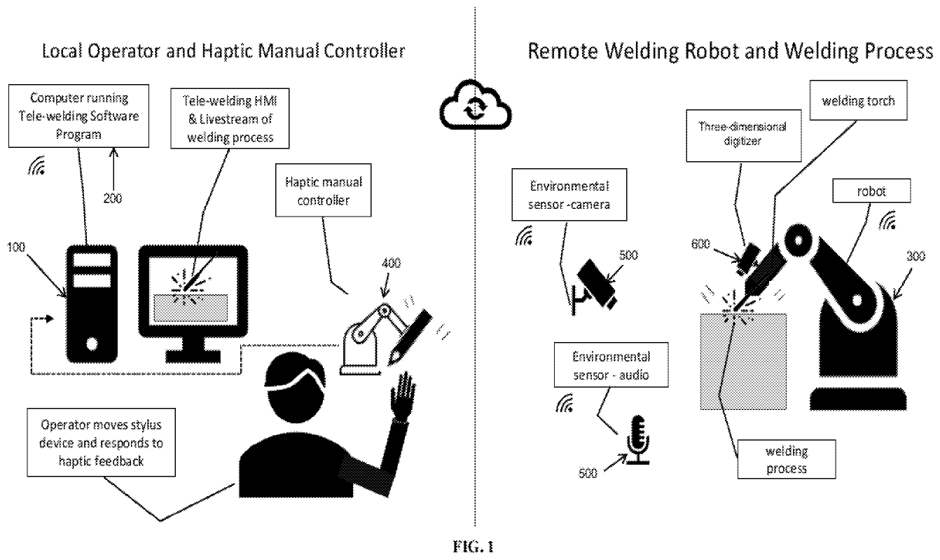

FIG. 1 provides a block diagram of an example implementation of the disclosed tele-welding system showing the basic components of the system. With reference to FIG. 1, an example tele-welding system includes the following components that when used together, allow an operator who is in direct contact with a hand-held stylus device to control welding machinery or other machinery that performs manual movements based on and coordinated with to the movements of the hand-held device despite the machinery being physically separate from the operator. The example implementation includes processor 100; control software 200; remote machinery 300; manual controller 400; sensors 500; and a three-dimensional digitizer 600.

Processor 100, which may be a computer or computing device that includes control hardware, runs an overall program for communicating with remote devices over the internet using wired or wireless protocols. Processor 100 is connected to manual controller 400, which may be a hand-held stylus, joystick, mouse, or any other electronic or computer-compatible motion control device having at least three degrees of rotational freedom. Processor 10 is connected to the Internet and opens a URL/webpage or digital media player software using an Internet browser or similar program. In some implementations, other open or closed computer networks are utilized.

Control software 200 runs on processor 100 and enables communication with and between remote machinery 300; manual controller 400; and the Internet. Control software 200 performs predetermined mathematical functions for transforming physical motion from manual controller 400 into movement or motion commands that are sent to remote machinery 300. In an example implementation, control software 200 uses digitized environmental data (e.g., point clouds) provided by three-dimensional scanning sensors 600 (such, for example, as laser detection and ranging (LIDAR), blue, white, or stereo scanning sensors), and mathematical transformations to convert a digital environment into haptic feedback felt by the user while holding controller 400, in real time, thereby providing the user with a physical sense of an actual working environment. Control software 200 also allows the user to initiate or stop communication with remote machinery 300, which typically includes a robot and robot controller. The robot and robot controller hardware are typically controlled by open source or proprietary communication protocols.

Tele-welding control software developed specifically for the disclosed tele-welding system includes an executable application that can be run on a system user's computer or on a computer in the same location as the remote machinery or on the robot controller system. The software provides a user interface for allowing the user to interact with the locally connected stylus device and the remote machinery in a simultaneous manner. The software provides a connection to remote machinery using a local area network (LAN), intranet, or the Internet, for the purpose of controlling the remote machinery. The software receives input from the user by the user interface to begin or end a tele-welding session or tele-welding process, and to set or change process settings or parameters or to set or change stylus device parameters. System software provides a method or process to communicate with at least one locally connected haptic stylus device, thereby allowing the user to directly manipulate the stylus device while querying the stylus positions and converting the positions to resultant movement of the remote machinery. In other implementations, the welding arc start/stop process is accomplished using buttons or other additional data input/output features included on the stylus device (controller).

Controller 400 may be a manually operated device such as a hand-held stylus, a computer mouse, a joystick, or any other suitable device, that can be used to record various hand motions of the user. Physical manipulations of controller 400 by the user are ultimately converted into the physical motions of remote machinery 300 by control software 200. Controller 400 also provides a haptic feedback response to the user, corresponding to either physical environmental objects that exist at the remote location or to virtual barriers.

A suitable controller 400 may be a stylus device that is a commercially available haptic feedback system including software libraries that are then imported into the tele-welding software program. The tele-welding software program queries the stylus device using the stylus software library functions for current axis positions. The tele-welding software program sets the haptic feedback response of the stylus device by sending commands to the stylus device using the stylus software library functions. The stylus device applies the commanded settings from the tele-welding software program to produce a sensation response felt by the user holding the stylus device. The commanded settings change the servo-motor power and response characteristics which produce sensations of touching surfaces of different densities or at differing levels of force, mass, gravity or speed. The tele-welding software program determines the settings for the type of response based on the current location of the remote machinery and from analysis of the environmental data queried from the remote environmental sensors.

The resultant motion performed on the remote machinery is with respect to the welding position. American Welding Society (AWS) welding joint positions for a typical groove weld of 1G, 2G or 3G are selected by the user before beginning welding with the tele-welding system. Alternately, all welding positions can be automatically determined by the environmental sensor data which can determine a current welding position and joint type. The weld joint type is a variable used by the tele-welding software program to determine the parameters required for the translation and rotation of the stylus motions into the resultant motion on the remote machinery and with respect to the welding position of the weld joint.

Sensors 500 may include cameras, microphones, digitizers, and other types of sensing devices, and may use optical systems, devices, and methods for determining the displacement of physical objects within an actual working environment that encompasses remote machinery 300 and the manufacturing process that is occurring. Sensors 500 may also use auditory systems, devices, and methods for capturing sounds within an actual working environment that encompasses remote machinery 300 and the manufacturing process that is occurring. Sensors 500 and 600 are used to collect digitized environmental data (e.g., point clouds) that is transmitted to and stored on processor 100. This digital environmental data is then used to determine when, how, and what type of physical sensation response is to be applied to the hand-held device for indicating the presence of a physical object in the work environment or proximity to a physical object or virtual barrier. With regard to welding processes: (i) inexpensive, digital cameras may be used to assist with proper line-up and weld placement; (ii) specialty arc welding process cameras may be used to provide a real-time weld puddle view; (iii) microphones may be used to add arc sounds to enable an experienced welder to create acceptable welds remotely; and (iv) livestreaming camera video and audio may be used to provide low latency real-time process data.

The three-dimensional digitizer 600, cooperates with sensors 500, which measure the displacement of objects relative to the sensors themselves, and provides a digitized topographical representation of the physical environment in which a manufacturing process is occurring. Optically-based processes such as, for example, infrared (IR), laser detection and ranging (LIDAR), blue, white, or laser vibrometer scanning systems can be used to create a point cloud or three-dimensional digital map of a remote manufacturing environment. Scanning and digitizing may be completed prior to the manufacturing process or may be completed in real-time as the manufacturing process is occurring. With regard to welding processes, scanning and digitizing the manufacturing environment may be used to: (i) send weld joint shapes to the system for enabling haptic response to the scanned area; (ii) alert the user of upcoming joint variation or obstacles in the weld path; and (iii) send the weld joint location to the system to align robots and remote manipulators to the same reference plane and field of view.

The disclosed tele-welding system provides real-time feedback of video and audio of the remote environment to the local system user. Video, audio or other sensor data is encoded using commercially available encoding hardware servers or an encoding software program running on a processor. The server or processor using commercially available software, publishes the encoded video and audio or other data stream to the internet or a LAN through a URL or web address. The published livestream uses a low latency protocol to stream the information to devices over the internet or on a local area network (LAN). The user can access the livestreamed video over the internet or LAN using the processor (e.g., a personal computer) and a commercial media player application that can read and play the audio or video stream on the user's personal computer.

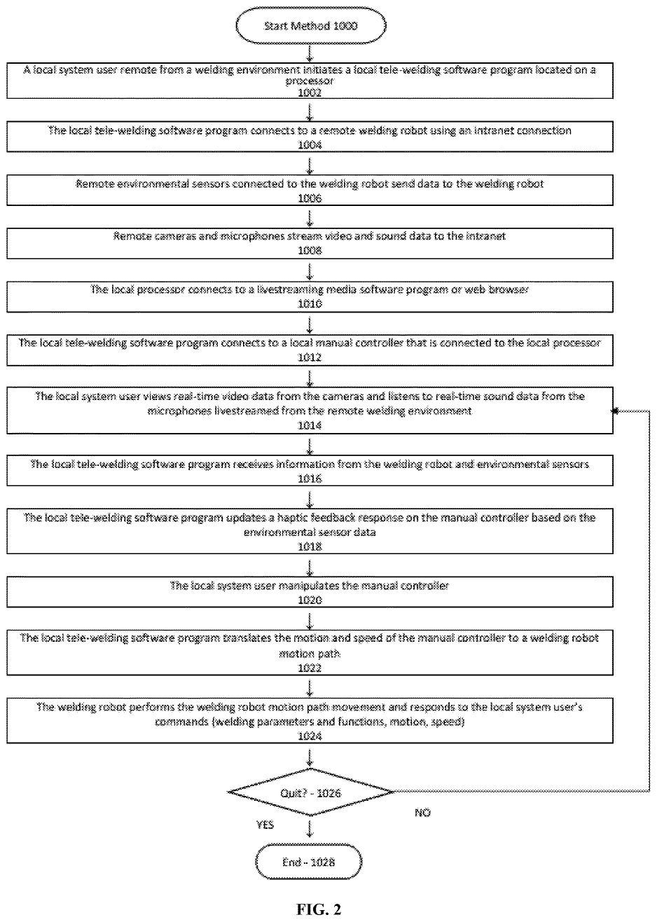

FIG. 2 provides a flow chart of an example method or process for using an example implementation of the disclosed tele-welding system. In FIG. 2, the method starts at step 1000; a local system user remote from a welding environment initiates a local tele-welding software program located on a processor at step 1002; the local tele-welding software program connects to a remote welding robot using an intranet connection at step 1004; remote environmental sensors connected to the welding robot send data to the welding robot at step 1006; remote cameras and microphones stream video and sound data to the intranet at step 1008; the local processor connects to a livestreaming media software program or web browser at step 1010; the local tele-welding software program connects to a local manual controller that is connected to the local processor at step 1012; the local system user views real-time video data from the cameras and listens to real-time sound data from the microphones livestreamed from the remote welding environment at step 1014; the local tele-welding software program receives information from the welding robot and environmental sensors at step 1016; the local tele-welding software program updates a haptic feedback response on the manual controller based on the environmental sensor data at step 1018; the local system user manipulates the manual controller at step 1020; the local tele-welding software program translates the motion and speed of the manual controller to a welding robot motion path at step 1022; the welding robot performs the welding robot motion path movement and responds to the local system user's commands (welding parameters and functions, motion, speed) at step 1024; and the system determines whether or not to terminate (quit) the process at step 1026 and either ends the process at step 1028 or continues the process from step 1014.

A primary advantage of the disclosed system is that it transfers manual dexterity and manual motion from a hand-held physical device in one location to machinery in a remote location, using wired or wireless communication to transfer the motion from one device to the other device. Other advantages of the disclosed system include the following: (a) a person with a physical disability can operate and machinery at a remote location without having to be physically present at the location where the machinery resides; (b) a worker can be relocated from the direct vicinity of a hazardous process or environment to a safer location for performing the work; (c) using a hand-held stylus device may be less physically taxing and create less physical fatigue than typical worker tools needed to perform certain jobs, thereby leading to increased production due to decreased physical fatigue; (d) highly skilled workers are not limited to geographical location because they can work from any physical location at which a communication protocol is available to transfer motion from the stylus (or other device) to the welding machinery; and (e) workers from all global time-zones can work at any time regardless of time-zone or traditional work shift time ranges. The disclosed system may be used: (i) by manufacturing enterprises; (ii) in physically demanding manual skill-level jobs; and (iii) by highly skilled workforce candidates, who retain the skills required to complete the job but have lost the physical tenacity or fitness to be able to perform the task over an extended time.

Any and all literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about” used throughout this specification are used to describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed inventive subject matter. Various functions and elements described herein may be partitioned differently from those shown without departing from the scope of the disclosed inventive subject matter. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the figures, only for facilitating description of the present invention and simplifying the description, rather than indicating or implying that the referred devices or elements must be in a particular orientation or constructed or operated in the particular orientation, and therefore they should not be construed as limiting the present invention. The terms “connected”, “mounted”, “fixed”, etc. should be understood in a broad sense. For example, “connected” may be a fixed connection, a detachable connection, or an integral connection; a direct connection, or an indirect connection through an intermediate medium. For an ordinary skilled in the art, the specific meaning of the above terms in the present invention may be understood according to specific circumstances.

It should be appreciated that all combinations of the foregoing concepts and additional concepts discussed in greater detail herein (provided such concepts are not mutually inconsistent) are contemplated as being part of the disclosed inventive subject matter. In particular, all combinations of claimed subject matter appearing at the end of this disclosure are contemplated as being part of the inventive subject matter disclosed herein. While the disclosed inventive subject matter has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed inventive subject matter in its broader aspects is not limited to any of the specific details, representative devices and methods, and/or illustrative examples shown and described. Accordingly, departures may be made from such details without departing from the spirit or scope of the general inventive concept.

1-33. (canceled)

34. A system for manually controlling a manufacturing process remotely, comprising:
(a) a manufacturing environment, wherein the manufacturing environment contains manufacturing equipment used for or related to a manufacturing process;
(b) at least one sensor positioned within the manufacturing environment in proximity to the manufacturing equipment, wherein the at least one sensor is configured to gather data from the manufacturing environment;
(c) at least one digitizer in communication with the at least one sensor for receiving data from the at least one sensor and converting the data into one or more three-dimensional digital maps of the manufacturing environment;
(d) at least one processor in communication with the at least one digitizer, wherein the at least one processor includes software for receiving and analyzing the one or more three-dimensional digital maps; and
(e) at least one manual controller in communication with the at least one processor,
(i) wherein the at least one manual controller receives motion input from a user of the at least one manual controller,
(ii) wherein the software on the at least one processor mathematically transforms the motion input into corresponding motion commands that are sent to the manufacturing equipment by the at least one processor,
(iii) wherein the manufacturing equipment, which is physically remote from the at least one manual controller, executes the motion commands in real-time during the manufacturing process to produce motion output, and
(iv) wherein the motion output of the manufacturing equipment differs from the motion input received by the at least one manual controller.

35. The system of claim 34, further comprising a computer network across which the processor communicates with the manufacturing equipment.

36. The system of claim 35 wherein real-time video and audio of the manufacturing environment are livestreamed to the user over the computer network using a low latency protocol.

37. The system of claim 34, wherein the manufacturing equipment includes welding equipment, measurement equipment, inspection equipment, remote assembly equipment, or combinations thereof.

38. The system of claim 34, wherein the manufacturing equipment moves with at least three degrees of freedom.

39. The system of claim 34, wherein the manufacturing equipment moves with at least six degrees of freedom.

40. The system of claim 34, wherein the at least one sensor is an optical sensor, an infrared sensor, a laser detection and ranging (LIDAR) sensor, a blue light scanning sensor, a white scanning light sensor, or a laser vibrometer scanning sensor.

41. The system of claim 34, wherein the digitizer converts data received from the sensors into a point cloud.

42. The system of claim 34, wherein the at least one manual controller provides a haptic feedback response to the user of the at least one manual controller.

43. The system of claim 42, wherein the haptic feedback response corresponds to physical environment objects at the remote location or to virtual barriers.

44. The system of claim 42, wherein the software uses digitized environmental data provided by the at least one sensor and mathematical transformations to convert a digital environment into the haptic feedback response felt by the user in real time while holding the at least one manual controller.

45. The system of claim 34, wherein converting the data into one or more three-dimensional digital maps of the manufacturing environment is completed prior to the manufacturing process or is completed in real-time as the manufacturing process is occurring.

46. The system of claim 34, wherein the processor uses the three-dimensional digital maps of the manufacturing environment to send workpiece feature geometry to the system for enabling haptic response to the scanned area; alert the user of upcoming variations or obstacles in the manufacturing equipment path; and send mapped feature locations to the system to align the manufacturing equipment and at least one manual controller to the same reference plane and field of view.

47. The system of claim 34, wherein a number of degrees of freedom of motion of the at least one manual controller differs from a number of degrees of freedom of motion of the manufacturing equipment.

48. The system of claim 34, wherein the software on the processor is accessed by the user through an Internet browser.

49. The system of claim 34, wherein the at least one manual controller is a hand-held stylus, a computer mouse, or a joystick.

50. A method for manually controlling a manufacturing process remotely, comprising:
(a) installing a manufacturing environment, wherein the manufacturing environment contains manufacturing equipment used for or related to a manufacturing process;
(b) positioning at least one sensor within the manufacturing environment in proximity to the manufacturing equipment, wherein the at least one sensor is configured to gather data from the manufacturing environment;
(c) connecting at least one digitizer to the at least one sensor for receiving data from the at least one sensor and converting the data into one or more three-dimensional digital maps of the manufacturing environment;
(d) connecting at least one processor to the at least one digitizer, wherein the at least one processor includes software for receiving and analyzing the one or more three-dimensional digital maps; and
(e) connecting at least one manual controller to the at least one processor,
(i) wherein the at least one manual controller receives motion input from a user of the at least one manual controller,
(ii) wherein the software on the at least one processor mathematically transforms the motion input into corresponding motion commands that are sent to the manufacturing equipment by the at least one processor,
(iii) wherein the manufacturing equipment, which is physically remote from the at least one manual controller, executes the motion commands in real-time during the manufacturing process to produce motion output, and
(iv) wherein the motion output of the manufacturing equipment differs from the motion input received by the at least one manual controller.

51. The method of claim 50, further comprising providing a computer network across which the processor communicates with the manufacturing equipment.

52. The method of claim 51, wherein real-time video and audio of the manufacturing environment are livestreamed to the user over the computer network using a low latency protocol.

53. The method of claim 50, wherein the manufacturing equipment includes welding equipment, measurement equipment, inspection equipment, remote assembly equipment, or combinations thereof.

54. The method of claim 50, wherein the manufacturing equipment moves with at least three degrees of freedom.

55. The method of claim 50, wherein the manufacturing equipment moves with at least six degrees of freedom.

56. The method of claim 50, wherein the at least one sensor is an optical sensor, an infrared sensor, a laser detection and ranging (LIDAR) sensor, a blue light scanning sensor, a white scanning light sensor, or a laser vibrometer scanning sensor.

57. The method of claim 50, wherein the digitizer converts data received from the sensors into a point cloud.

58. The method of claim 50, wherein the at least one manual controller provides a haptic feedback response to the user of the at least one manual controller.

59. The method of claim 58, wherein the haptic feedback response corresponds to physical environment objects at the remote location or to virtual barriers.

60. The method of claim 58, wherein the software uses digitized environmental data provided by the at least one sensor and mathematical transformations to convert a digital environment into the haptic feedback response felt by the user in real time while holding the at least one manual controller.

61. The method of claim 50, wherein converting the data into one or more three-dimensional digital maps of the manufacturing environment is completed prior to the manufacturing process or is completed in real-time as the manufacturing process is occurring.

62. The method of claim 50, wherein the processor uses the three-dimensional digital maps of the manufacturing environment to send workpiece feature geometry to the system for enabling haptic response to the scanned area; alert the user of upcoming variations or obstacles in the manufacturing equipment path; and send mapped feature locations to the system to align the manufacturing equipment and at least one manual controller to the same reference plane and field of view.

63. The method of claim 50, wherein a number of degrees of freedom of motion of the at least one manual controller differs from a number of degrees of freedom of motion of the manufacturing equipment.

64. The method of claim 50, wherein the software on the processor is accessed by the user through an Internet browser.

65. The method of claim 50, wherein the at least one manual controller is a hand-held stylus, a computer mouse, or a joystick.
